(19) United States
(12) Patent Application Publication
(10) Pub. No.: US 2008/0024048 A1
(43) Pub. Date: Jan. 31, 2008

(54) Field Emission Devices

(75) Inventors: Cheng-Chung LEE, Taitung County (TW); Yu-Yang CHANG, Tainan City (TW); Ming-Hung LIN, Taipei City (TW); Bing-Nan LIN, Taichung City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: INDUSTRIAL TECHNOLOGY RESEARCH INSTITUTE, Chutung (TW)

(21) Appl. No.: 11/857,879

(22) Filed: Sep. 19, 2007

Related U.S. Application Data
(63) Continuation-in-part of application No. 11/110,613, filed on Apr. 19, 2005, now abandoned.

(51) Int. Cl. H01J 7/24

(52) U.S. Cl. 313/46

(57) ABSTRACT

A field emission device comprising a first substrate, a second substrate spaced apart from the first substrate, a first metal layer on the first substrate, the first metal layer including a number of first metal lines, a second metal layer over the first metal layer, the second metal layer including a number of second metal lines, emitters over the first metal layer, the emitters being configured to emit electrons toward the second substrate, a luminescent layer between the first substrate and the second substrate, the luminescent layer being configured to provide light when the electrons impinge thereon, and a third metal layer between the second substrate and the luminescent layer, the third metal layer being configured to reflect the light from the luminescent layer toward the first substrate, wherein the first metal lines are substantially parallel to the second metal lines.

### CROSS-REFERENCE TO RELATED APPLICATIONS

This application is a continuation-in-part of U.S. patent application Ser. No. 11/110,613, filed Apr. 19, 2005, which is herein incorporated by reference.

### FIELD OF THE INVENTION

The present invention relates generally to an electron emitting device and, more particularly, to a field emission device able to serve as a light source.

### BACKGROUND OF THE INVENTION

In recent years, flat-panel display devices have been developed and widely used in electronic applications. Examples of flat-panel display devices include the liquid crystal display (“LCD”), plasma display panel (“PDP”) and field emission display (“FED”) devices. FEDs have received considerable attention as a next generation display device having the advantages of LCDs and PDPs. FEDs, which operate on the principle of field emission of electrons from microscopic tips, are known to be capable of overcoming some of the limitations and provides significant advantages over conventional LCDs and PDPs. For example, FEDs have higher contrast ratios, wider viewing angles, higher maximum brightness, lower power consumption, shorter response times and broader operating temperature ranges compared to conventional LCDs and PDPs. Consequently, FEDs are used in a wide variety of applications ranging from home televisions to industrial equipment and computers.

One of the most important differences between an FED and an LCD is that, unlike the LCD, the FED may produce its own light source. The FED does not require complicated, power-consuming backlights and filters. Almost all light generated by an FED is viewable by a user. Thus, the costly light source of an LCD may be eliminated. With the property of self-luminescence, a field emission device may function to serve as an independent light source rather than a display device. The principle of field emission of electrons is briefly discussed below. FIG. 1 is a schematic cross-sectional diagram of a conventional field emission device 10. Referring to FIG. 1, the field emission device 10, which may function to serve as a light source, includes a first substrate 12, a cathode assembly 14, a second substrate 22, a transparent electrode 24 and a phosphor layer 26. The cathode assembly 14 may emit electrons, which are accelerated toward the phosphor layer 26. The phosphor layer 26 may provide luminescence when the emitted electrons collide with phosphor particles. Light provided from the phosphor layer 26 transmits through the transparent electrode 24, for example, an indium tin oxide (“ITO”) layer, and the second substrate 22 to a display device (not shown), for example, an LCD device attached to second substrate 22. However, the field emission device 10 may be disadvantageous in that the temperature at the second substrate 22 may be too high to adversely affect the performance or even lifetime of the attached display device.

### BRIEF SUMMARY OF THE INVENTION

A novel field emission device is disclosed, which may obviate one or more problems resulting from the limitations and disadvantages of the prior art.

Examples of the present invention may provide a field emission device comprising a first substrate, a second substrate spaced apart from the first substrate, a cathode structure between the first substrate and the second substrate, the cathode structure being configured to emit electrons toward the second substrate, a luminescent layer between the first substrate and the second substrate, the luminescent layer being configured to provide light when the electrons impinge thereon, and a reflecting layer between the second substrate and the luminescent layer, the reflecting layer being configured to reflect the light from the luminescent layer toward the first substrate, wherein the cathode structure includes a first metal layer comprising a number of first metal lines and a second metal layer comprising a number of second metal lines, and wherein the first metal lines and the second metal lines are substantially orthogonal to each other.

Some examples of the present invention may also provide a field emission device comprising a first substrate, a second substrate spaced apart from the first substrate, a first metal layer on the first substrate, the first metal layer including a number of first metal lines, a second metal layer over the first metal layer, the second metal layer including a number of second metal lines, emitters over the first metal layer, the emitters being configured to emit electrons toward the second substrate, a luminescent layer between the first substrate and the second substrate, the luminescent layer being configured to provide light when the electrons impinge thereon, and a third metal layer between the second substrate and the luminescent layer, the third metal layer being configured to reflect the light from the luminescent layer toward the first substrate, wherein the first metal lines are substantially parallel to the second metal lines.

Examples of the present invention may further provide a field emission device comprising a number of first metal lines extending in parallel with one another on a substrate; a number of second metal lines extending in parallel with one another on the substrate, the number of second metal lines being interleaved with the number of first metal lines; a number of emitters each of which is arranged over one of the number of first metal lines, the number of emitters being configured to emit electrons toward a second substrate being spaced apart from the first substrate; a luminescent layer between the first substrate and the second substrate, the luminescent layer being configured to provide light when the electrons impinge thereon, and a reflecting layer between the second substrate and the luminescent layer, the reflecting layer being configured to reflect the light from the luminescent layer toward the first substrate.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one example of the present invention and together with the description, serves to explain the principles of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1 is a schematic cross-sectional diagram of a conventional field emission device;

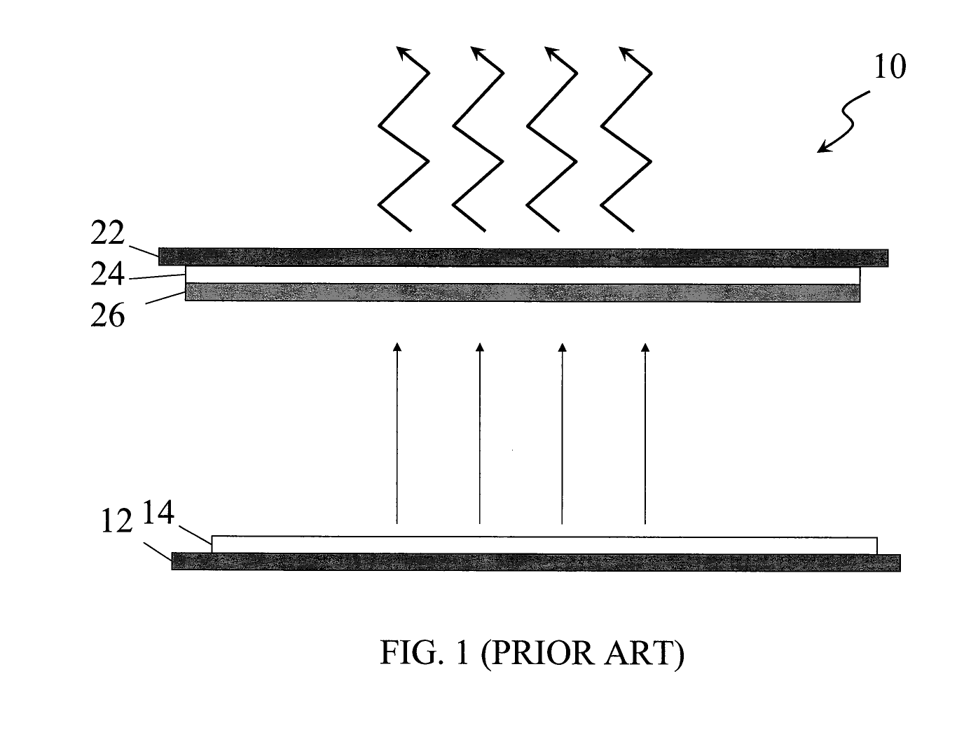

FIG. 2A is a schematic cross-sectional diagram of a field emission device in accordance with an example of the present invention;

FIG. 2B is a schematic cross-sectional diagram of a luminescent layer of the field emission device illustrated in FIG. 2A;

FIG. 2C is a schematic cross-sectional diagram of a cathode structure of the field emission device illustrated in FIG. 2A;

FIG. 3A is a schematic cross-sectional diagram of a field emission device in accordance with another example of the present invention;

FIG. 3B is a top planar view of a cathode structure of the field emission device illustrated in FIG. 3A;

FIG. 3C is a top planar view of another cathode structure of the field emission device illustrated in FIG. 3A;

FIG. 4A is a schematic cross-sectional diagram of a field emission device in accordance with still another example of the present invention;

FIG. 4B is a top planar view of a cathode structure of the field emission device illustrated in FIG. 4A; and

FIG. 5 is a schematic cross-sectional diagram of a field emission device in accordance with yet another example of the present invention.

### DETAILED DESCRIPTION OF THE INVENTION

In this detailed description, for purposes of explanation, numerous specific details are set forth to illustrate examples of the present invention. One skilled in the art will appreciate, however, that examples of the present invention may be practiced without these specific details. Furthermore, one skilled in the art can readily appreciate that the specific sequences in which methods are presented and performed are illustrative and it is contemplated that the sequences can be varied and still remain within the spirit and scope of embodiments of the present invention.

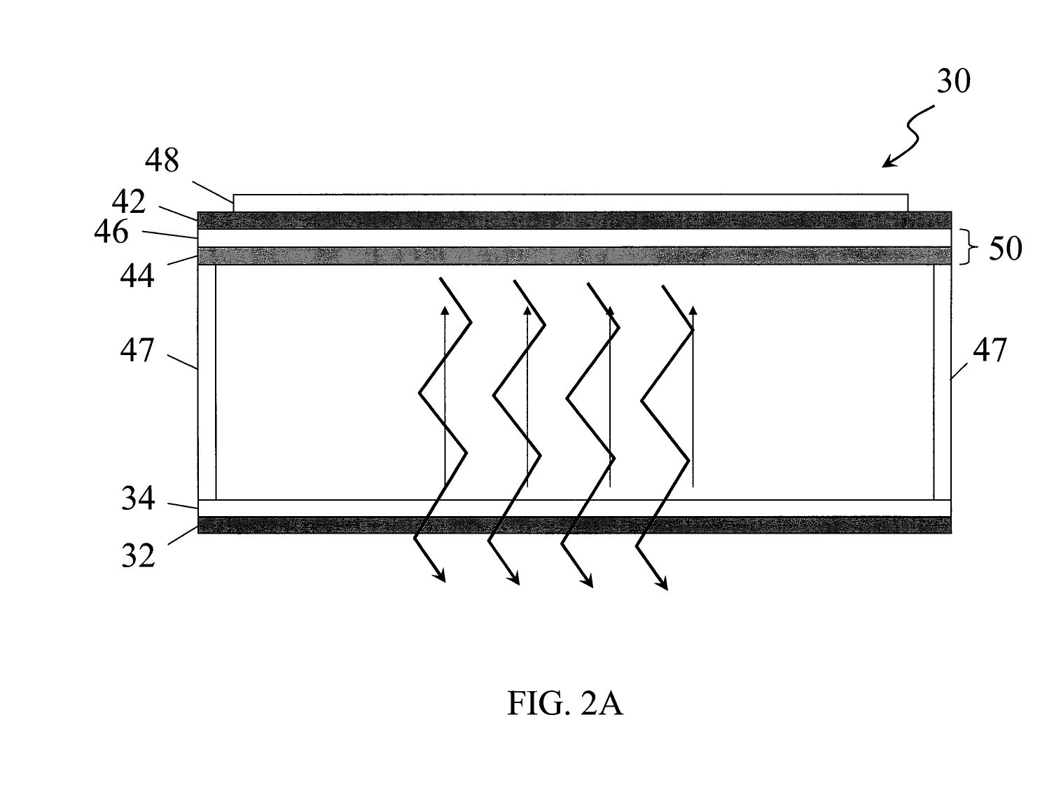

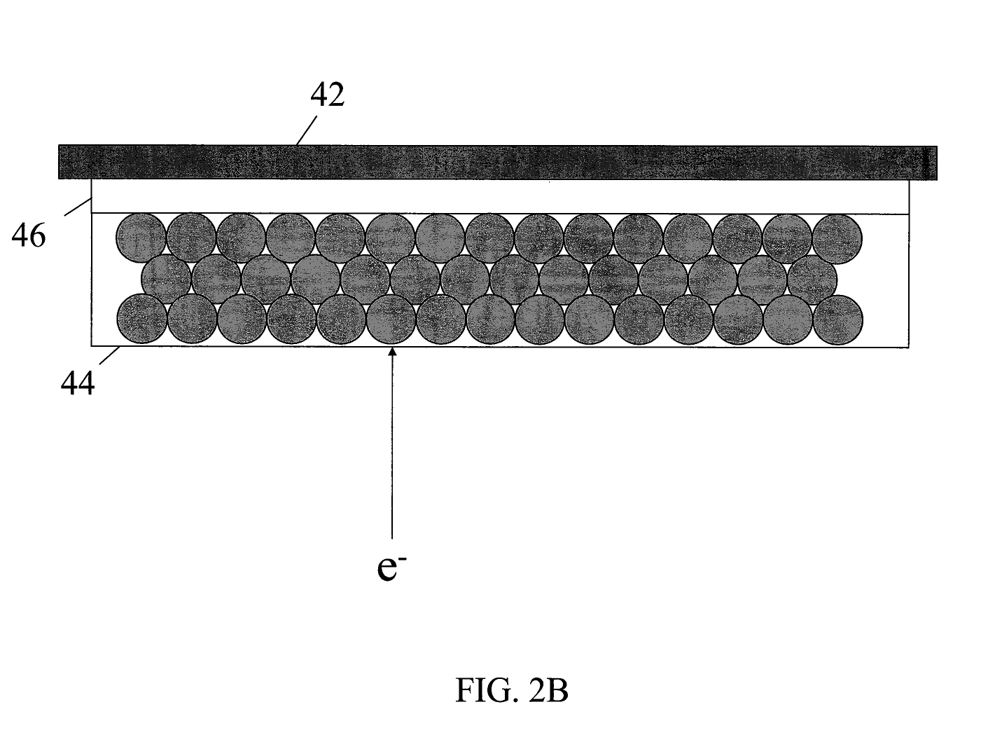

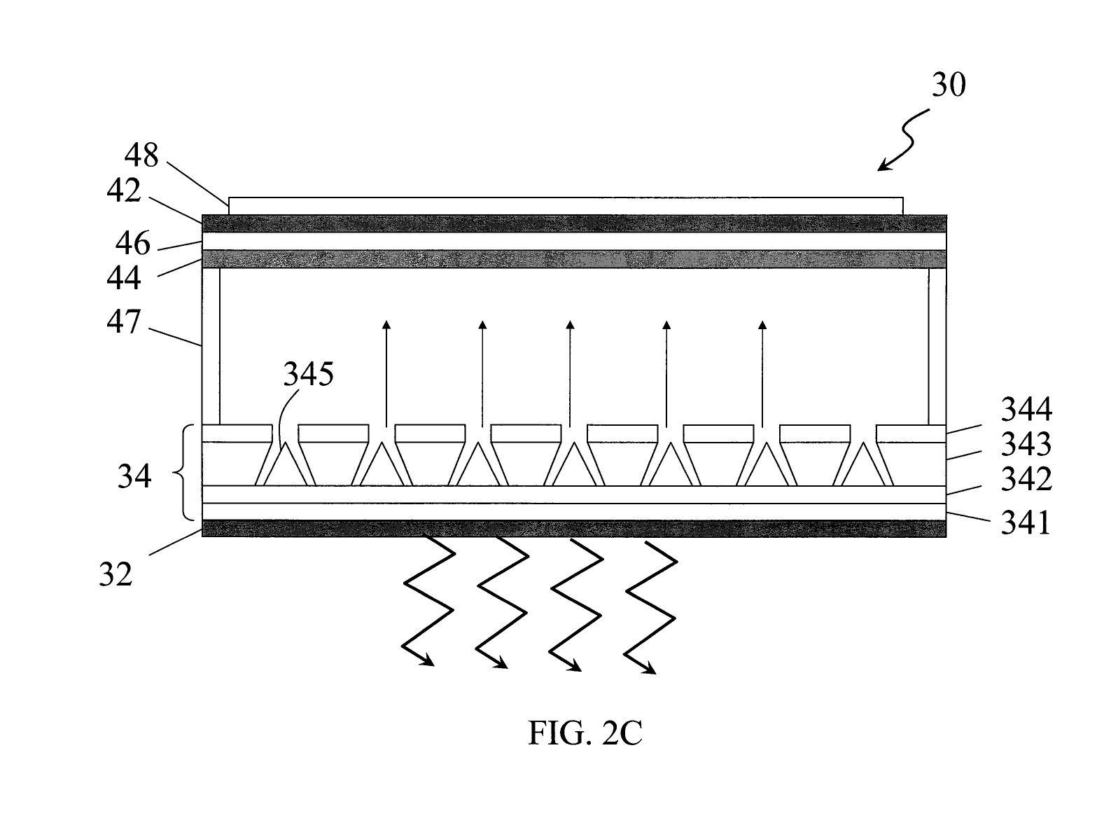

FIG. 2A is a schematic cross-sectional diagram of a field emission device 30 in accordance with an example of the present invention. Referring to FIG. 2A, the field emission device 30 may include a first substrate 32, a cathode structure 34, a second substrate 42, a reflecting layer 46 and a luminescent layer 44. The reflecting layer 46 and the luminescent layer 44 may be collectively called an “anode structure” 50. The first substrate 32 and the second substrate 42 may include, for example, glass substrates. The cathode structure 34 may function to emit electrons toward the luminescent layer 44, which in turn provides luminescence when the emitted electrons impinge thereon. Light generated from the luminescent layer 44, as indicated by straight arrow lines, may be reflected by the reflecting layer 46 toward the first substrate 32, as indicated by curved arrow lines.

In one example consistent with the present invention, the field emission device 30 may serve as an independent light source. In another example, the field emission device 30 may serve as a light source for a display device, for example, a liquid crystal display (“LCD”) device (not shown). The display device may be attached to the first substrate 32 of the field emission device 30 to receive the light emitted therefrom. The temperature at the first substrate 32 may be substantially equal to room temperature, and therefore does not adversely affect the performance of the attached display device. The field emission device 30 may further include a heat conductor 48, for example, a heat sink, attached to the second substrate 42. The heat conductor 48 may be arranged to discharge excessive heat generated at the second substrate 42.

The field emission device 30 may further include spacers 47 disposed between the anode structure 50 and the cathode structure 34 to maintain a predetermined spacing therebetween. The spacers 47 may be affixed to the anode structure 50 and the cathode structure 34 by using a glass fit sealant. An inter space region defined by the anode structure 50, the cathode structure 34 and the spacers 47 may be maintained at a vacuum of approximately 10⁻⁶ Torr to 10⁻⁷ Torr to ensure continued accurate emission of electrons from the cathode structure 34.

In addition to reflecting the light from the luminescent layer 44, the reflecting layer 46 may also serve as an electrode. In one example according to the present invention, the reflecting layer 46 may include a material selected from one of aluminum (Al), silver (Ag), platinum (Pt), gold (Au) and copper (Cu).

FIG. 2B is a schematic cross-sectional diagram of the luminescent layer 44 of the field emission device 30 illustrated in FIG. 2A. Referring to FIG. 2B, the luminescent layer 44 may include a number of sub-layers (not numbered) of phosphor particles. The sub-layers of phosphor particles may be formed on the reflecting layer 46 by for example, a screen printing process or a spin coating process. When the emitted electrons strike the phosphor particles, the luminescent layer 44 emits light. The thickness of the luminescent layer 44 may be approximately 5 micrometers (μm). Also referring to FIG. 2A, each of the first substrate 32 and the second substrate 42 may be approximately 1.1 to 2.8 millimeters (mm), the cathode structure 34 may range from approximately 6 μm to 10 μm, and the reflecting layer 46 may range from approximately 0.3 μm to 0.5 μm in thickness. Moreover, the thickness of the heat conductor 48 may be approximately 7 mm to 12 mm, and the height of the spacers 47 may be approximately 1 mm to 4 mm.

FIG. 2C is a schematic cross-sectional diagram of the cathode structure 34 of the field emission device 30 illustrated in FIG. 2A. Referring to FIG. 2C, the cathode structure 34 may include a first metal layer 341, an insulating layer 343, a second metal layer 344 and emitters 345. The first metal layer 341 may be comprised of a number of first metal lines extending in a first direction. The second metal layer 344 may be comprised of a number of second metal lines extending over the first metal lines in a second direction substantially orthogonal to the first direction.

The first metal layer 341 may be formed over first substrate 32 with a metal such as chromium (Cr) by, for example, a deposition process followed by a photolithography process. In one example according to the present invention, a resistive layer 342 may optionally be formed over the first metal layer 341 with amorphous silicon in order to ensure uniform emission of electrons. The insulating layer 343 may include a dielectric material such as silicon dioxide (SiO₂). The second metal layer 344 may be formed over the first metal layer 341 with a metal such as Cr by, for example, a deposition process followed by a photolithography process. The second metal lines of the second metal layer 344 may be arranged at regular intervals. The emitters 345, in the form of conical micro-tip formed of a metal such as molybdenum (Mo), may be located on the first metal lines within spaces defined by the intervals. The emitters 345 may be formed by a chemical vapor deposition (“CVD”) process, a plasma-enhanced chemical vapor deposition (“PECVD”) process, or other suitable chemical-physical deposition processes such as reactive sputtering, ion-beam sputtering and dual ion beam sputtering.

The second metal layer 344 may be electrically connected to a relatively positive voltage source, while the first metal layer 341 may be electrically connected to a relatively negative voltage source. Thus, as a voltage is applied across the first metal layer 341 and the second metal layer 344, electrons are emitted by the emitters 345. The emitted electrons are accelerated toward the reflecting layer 46, to which a voltage of, for example, several hundred to several thousand volts is applied. In one example according to the present invention, the voltage levels at first metal layer 341 and second metal layer 344 are approximately 0 volts and 100 to 200 volts, respectively. The reflecting layer 46 may be electrically connected to a power supply of approximately 1000 volts to 8000 volts.

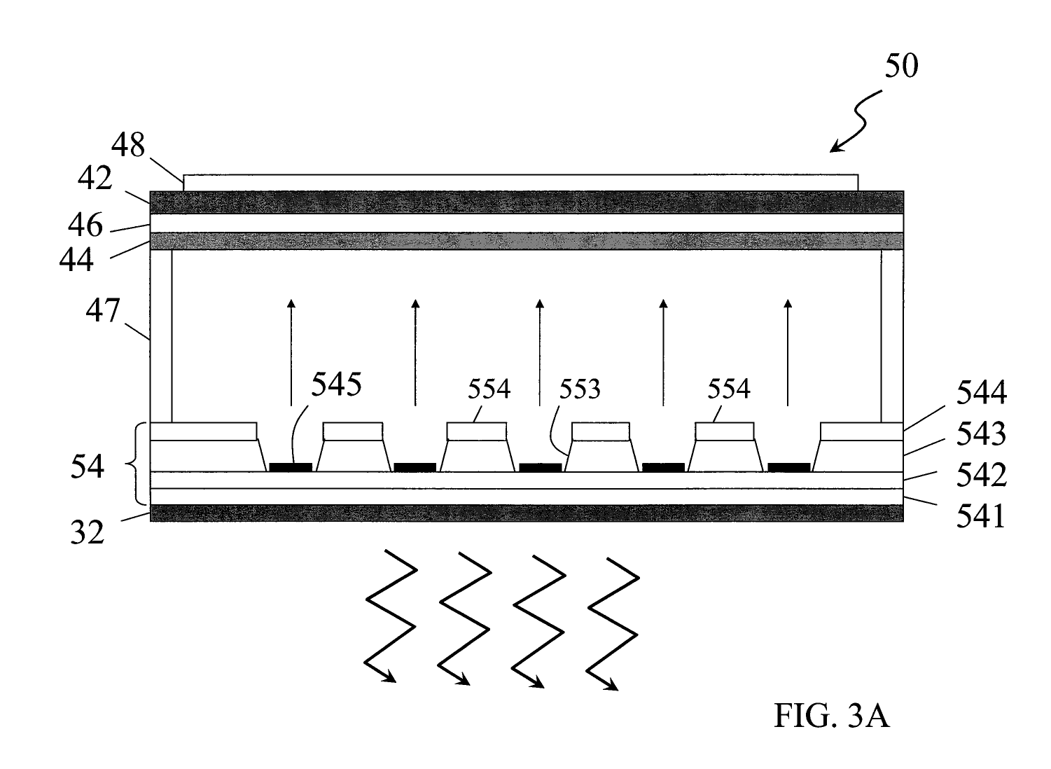

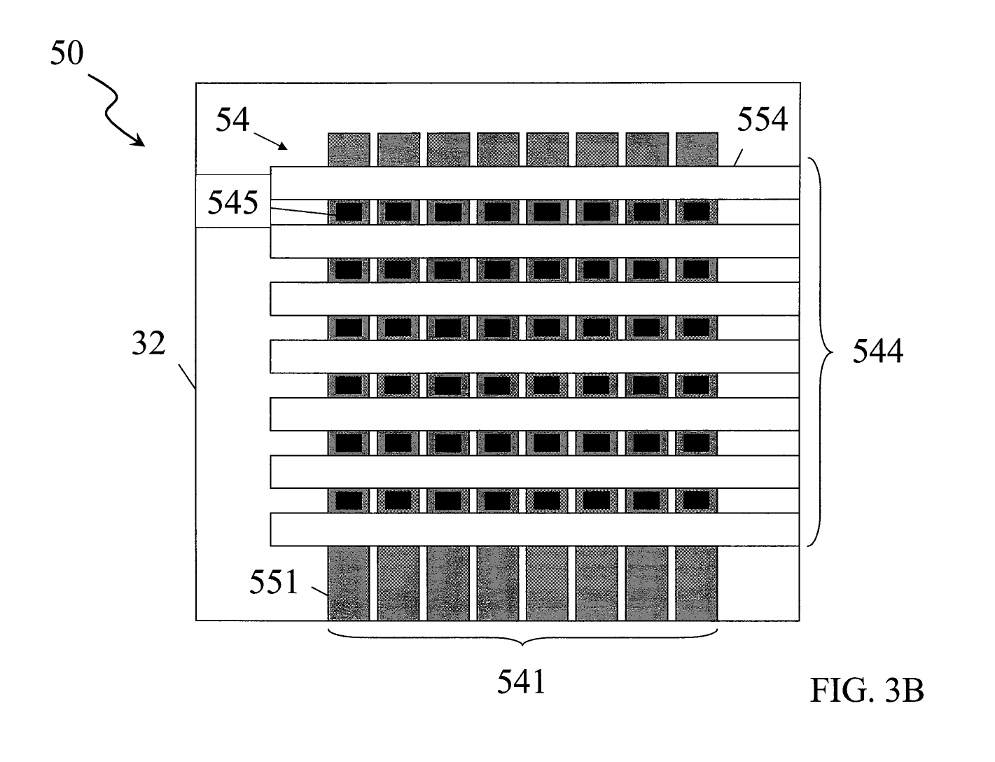

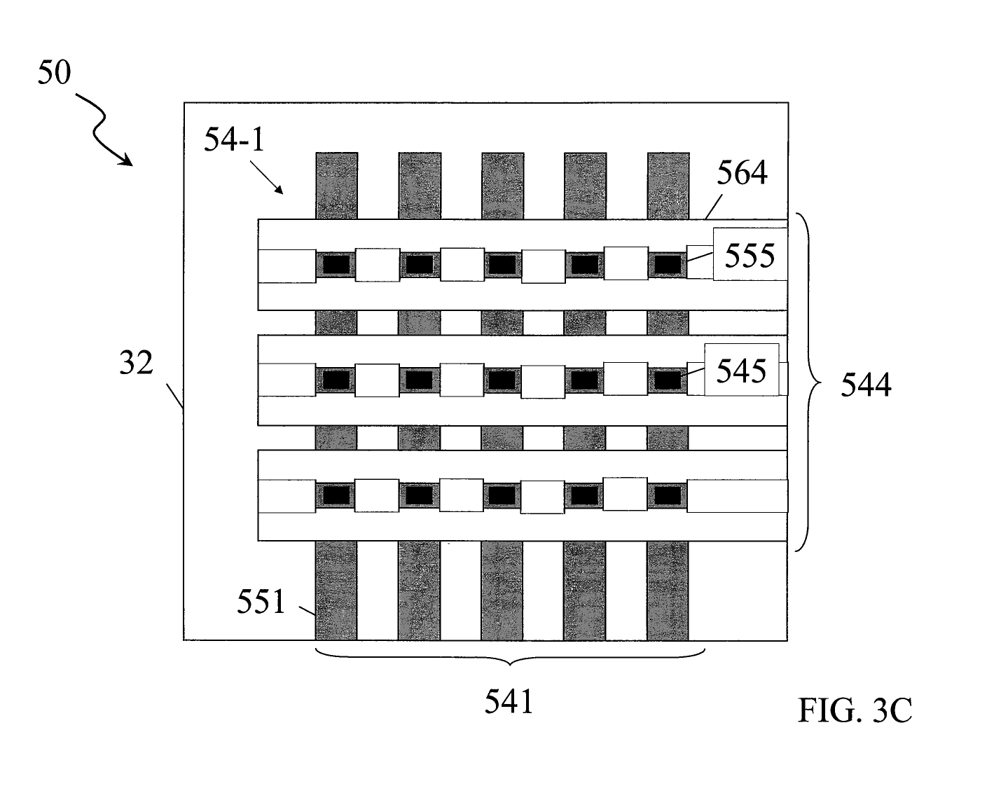

FIG. 3A is a schematic cross-sectional diagram of a field emission device 50 in accordance with another example of the present invention. Referring to FIG. 3A, the field emission device 50 may be similar to the field emission device 30 described and illustrated with reference to FIG. 2C except that, for example, a cathode structure 54 in place of the cathode structure 34. Specifically, the cathode structure 54 may include a patterned first metal layer 541 on the first substrate 32, a pedestal layer 543 over the first substrate 32, a patterned second metal layer 544 on the pedestal layer 543, and emitters 545. The patterned second metal layer 544 may serve as a switch for the cathode structure 54 and function to switch on or switch off the emission of electrons from the emitters 545. To facilitate the switch operation, the patterned second metal layer 544 may be disposed closer to the reflecting layer 46 then the emitters 545. The pedestal layer 543, which functions to serve as a pedestal, may raise the level of the patterned second metal layer 544 formed thereon. The pedestal layer 543 may include a number of pedestal units 553 extending over and orthogonal to the patterned first metal layer 541. In one example, the pedestal layer 543 may include a patterned insulating layer made of, for example, silicon dioxide. The cathode structure 54 may optionally include a resistive layer 542 between the patterned first metal layer 541 and the emitters 545.

FIG. 3B is a top planar view of the cathode structure 54 of the field emission device 50 illustrated in FIG. 3A. Referring to FIG. 3B, the patterned first metal layer 541 may include a number of first metal lines 551 extending in parallel with one another in a first direction. The pedestal layer 543 may then be formed over the patterned first metal layer 541. The number of pedestal units 553 may be arranged one another at a predetermined interval not to interfere with the emission of electrons. Furthermore, the patterned second metal layer 544 may include a number of second metal lines 554 extending in parallel with one another in a second direction substantially orthogonal to the first direction. Each of the number of second metal lines 554 may be arranged on one of the number of pedestal units 553. Each of the emitters 545 may be arranged on one the number of first metal lines 551 within the intervals defined by the number of pedestal units 553.

In one example according to the present invention, the patterned first metal layer 541, the pedestal layer 543 and the patterned second metal layer 544 may be formed by a screen printing process or other suitable processes such as a photolithography process and an electrophoretic deposition (EPD) process. Furthermore, the optional resistive layer 542 and the emitters 545 may also be formed by one of the screen printing, photolithographic and EPD process. Each of the first metal lines 551 may have a length of approximately 230 mm to 360 mm and a width of approximately 100 to 200 μm. Each of the second metal lines 554 may have a length of approximately 230 to 360 mm and a width of approximately 80 to 160 μm. Furthermore, each of the emitters 545 may have a width ranging from approximately 80 to 180 μm but the width may vary as the size of the first and second metal lines 551 and 554 vary in other applications.

FIG. 3C is a top planar view of another cathode structure 54-1 of the field emission device 50 illustrated in FIG. 3A. Referring to FIG. 3C, the cathode structure 54-1 may be similar to the cathode structure 54 described and illustrated with reference to FIG. 3B except that, for example, a number of second metal lines 564 in place of the number of second metal lines 554. Specifically, each of the number of second metal lines 564 may include a number of windows 555, each of which may expose one of the emitters 545 arranged on (in the absence of the resistive layer 542) or over (in the presence of the resistive layer 542) the number of first metal lines 541. The number of windows 555 may be formed in the same photolithographic process for forming the number of second metal lines 544.

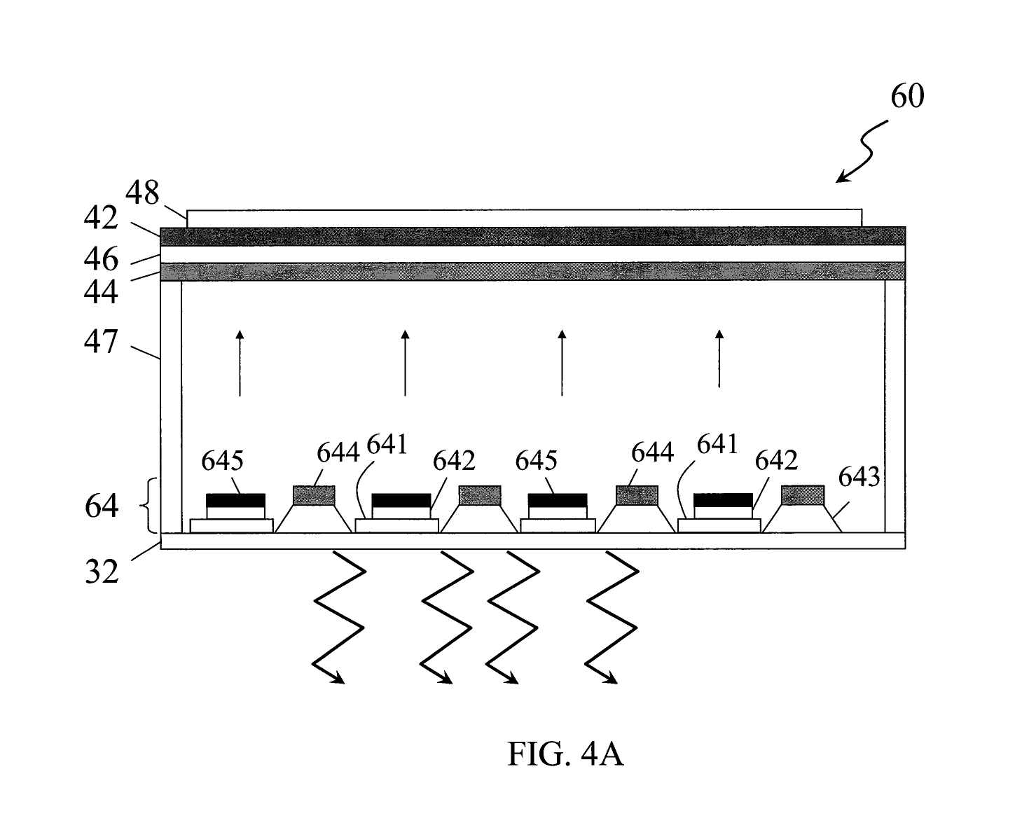

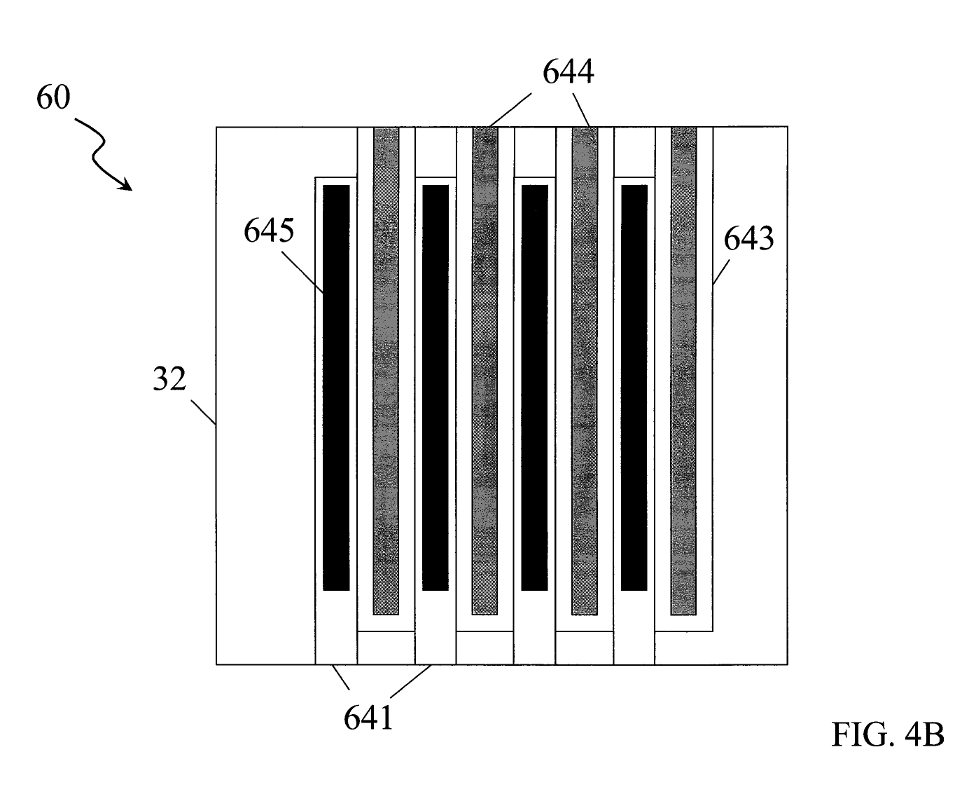

FIG. 4A is a schematic cross-sectional diagram of a field emission device 60 in accordance with still another example of the present invention. Referring to FIG. 4A, the field emission device 60 may be similar to the field emission device 50 described and illustrated with reference to FIG. 3A except that, for example, a cathode structure 64 in place of the cathode structure 54. Specifically, the cathode structure 64 may include a number of first metal lines 641 on the first substrate 32, a number of pedestal units 643 arranged on the first substrate 32 and interleaved with the number of first metal lines 641, a number of second metal lines 644 each being arranged on one of the number of pedestal units 643, and a number of emitters 645 over the first metal lines 641. The first metal lines 641 and the second metal lines 644 may extend in parallel with each other. Furthermore, the second metal lines 644 may be disposed closer to the reflecting layer 46 then the emitters 645 and in turn the first metal lines. In one example, each of the number of pedestal units 643 may include an insulating material. In another example, each of the number of pedestal units 643 may include a metal material, which may include substantially the same material, for example, Cr, as the first and second metal lines 641 and 644. The cathode structure 64 may optionally include a number of resistive units 642 each of which may be provided between one of the first metal lines 641 and one of the emitters 645.

FIG. 4B is a top planar view of the cathode structure 64 of the field emission device 60 illustrated in FIG. 4A. Referring to FIG. 4B, the second metal lines 644 may extend above and in parallel with the first metal lines 641. As compared to the cathode structure 54 illustrated in FIG. 3A, the cathode structure 64 with the first and second lines 641 and 644 extending in substantially the same direction may enhance flux of the reflected light at the first substrate 32.

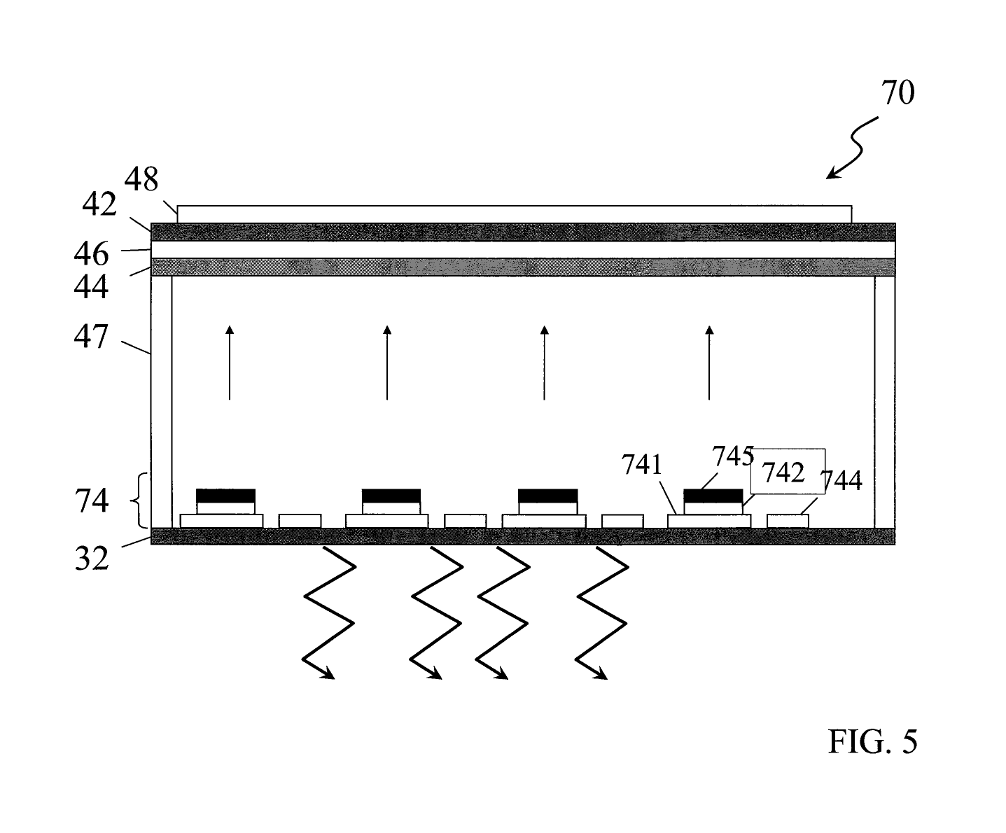

FIG. 5 is a schematic cross-sectional diagram of a field emission device 70 in accordance with yet another example of the present invention. Referring to FIG. 5, the field emission device 70 may be similar to the field emission device 60 described and illustrated with reference to FIG. 4A except that, for example, a cathode structure 74 in place of the cathode structure 64. Specifically, the cathode structure 74 may include a number of first metal lines 741 on the first substrate 32, a number of second metal lines 744 arranged on the first substrate 32 and interleaved with the number of first metal lines 741, and a number of emitters 745 over the first metal lines 741. The first metal lines 741 and the second metal lines 744 may extend in parallel with each other. In one example according to the present invention, the number of first metal lines 741 and the number of second metal lines 744 may be fabricated simultaneously by, for example, one of a screen printing, photolithography and EPD process. Furthermore, the cathode structure 74 may optionally include a number of resistive units 742 each of which may be provided between one of the first metal lines 741 and one of the emitters 745.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A field emission device comprising:
a first substrate;
a second substrate spaced apart from the first substrate;
a cathode structure between the first substrate and the second substrate, the cathode structure being configured to emit electrons toward the second substrate;
a luminescent layer between the first substrate and the second substrate, the luminescent layer being configured to provide light when the electrons impinge thereon; and
a reflecting layer between the second substrate and the luminescent layer, the reflecting layer being configured to reflect the light from the luminescent layer toward the first substrate,
wherein the cathode structure includes a first metal layer comprising a number of first metal lines and a second metal layer comprising a number of second metal lines, and
wherein the first metal lines and the second metal lines are substantially orthogonal to each other.

2. The device of claim 1 further comprising a heat conductor attached to the second substrate.

3. The device of claim 1, wherein the reflecting layer includes a material selected from one of aluminum (Al), silver (Ag), platinum (Pt), gold (Au) and copper (Cu).

4. The device of claim 1, wherein the cathode structure includes a number of pedestal units being arranged one another over the first metal layer at a predetermined interval and extending orthogonal to the number of first metal lines.

5. The device of claim 4, wherein each of the number of second metal lines is arranged on one of the number of pedestal units.

6. The device of claim 4 further comprising a number of emitters arranged over the number of first metal lines within the intervals.

7. The device of claim 6, wherein each of the number of second metal lines includes a number of windows to expose a row of the number of emitters.

8. The device of claim 1, wherein the cathode structure includes a resistive layer on the first metal layer.

9. A field emission device comprising:
a first substrate;
a second substrate spaced apart from the first substrate;
a first metal layer on the first substrate, the first metal layer including a number of first metal lines;
a second metal layer over the first metal layer, the second metal layer including a number of second metal lines;
emitters over the first metal layer, the emitters being configured to emit electrons toward the second substrate;
a luminescent layer between the first substrate and the second substrate, the luminescent layer being configured to provide light when the electrons impinge thereon; and
a third metal layer between the second substrate and the luminescent layer, the third metal layer being configured to reflect the light from the luminescent layer toward the first substrate,
wherein the first metal lines are substantially parallel to the second metal lines.

10. The device of claim 9 further comprising a heat conductor attached to the second substrate.

11. The device of claim 9 further comprising spacers being arranged to space the first substrate apart from the second substrate.

12. The device of claim 9, wherein the third metal layer includes a material selected from one of aluminum (Al), silver (Ag), platinum (Pt), gold (Au) and copper (Cu).

13. The device of claim 9, wherein the cathode structure includes a resistive layer on the first metal layer.

14. The device of claim 9 further comprising a pedestal layer including a number of pedestal units, wherein the number of pedestal units are interleaved with the number of first metal lines.

15. The device of claim 14, wherein each of the number of second metal lines is arranged on one of the number of pedestal units.

16. The device of claim 14, wherein the pedestal layer includes one of a metal material and an insulating material.

17. The device of claim 9, wherein the second metal layer is disposed closer to the luminescent layer than the first metal layer.

18. A field emission device comprising:
a number of first metal lines extending in parallel with one another on a substrate;
a number of second metal lines extending in parallel with one another on the substrate, the number of second metal lines being interleaved with the number of first metal lines;
a number of emitters each of which is arranged over one of the number of first metal lines, the number of emitters being configured to emit electrons toward a second substrate being spaced apart from the first substrate;
a luminescent layer between the first substrate and the second substrate, the luminescent layer being configured to provide light when the electrons impinge thereon; and
a reflecting layer between the second substrate and the luminescent layer, the reflecting layer being configured to reflect the light from the luminescent layer toward the first substrate.

19. The device of claim 18 further comprising a number of resistive units, wherein each of the number of resistive units is arranged on one of the number of first metal lines.

20. The device of claim 18, wherein the reflecting layer includes a material selected from one of aluminum (Al), silver (Ag), platinum (Pt), gold (Au) and copper (Cu).
